(19) United States
(12) Patent Application Publication
(10) Pub. No.: US 2018/0040029 A1
(43) Pub. Date: Feb. 8, 2018

(54) CREATIVE SCORE FOR ONLINE CONTENT

(71) Applicant: Facebook, Inc., Menlo Park, CA (US)

(72) Inventors: George Xiangwen Zeng, San Francisco, CA (US); Aditya Pradip Kulkarni, Sunnyvale, CA (US); Robert Kamil Boczek, Seattle, WA (US); Avi Samuel Gavlovski, Kirkland, WA (US); Anwar Saipulla, Redmond, WA (US)

(21) Appl. No.: 15/227,851

(22) Filed: Aug. 3, 2016

(51) Int. Cl. G06Q 30/02; G06N 99/00

(52) U.S. Cl. CPC G06Q 30/0269; G06Q 30/0277; G06N 99/005

(57) ABSTRACT

An online system provides feedback to a content provider creating a content item for a target audience. The feedback may include a score, recommendation, or error notification for a creative such as an image, video, or text to be included in the content item. The score indicates a likelihood that users of the online system will interact with the content item having the creative. Modifying the content item based on recommendations may result in a different score for the content item. The online system trains a machine learning model to generate the scores. The model learns which creatives are popular among particular audiences. The online system provides error notifications if the content item violates a rule. The online system can generate the content item even if there are rule violations. The feedback is displayed inline on a graphical user interface while the content provider is creating the content item.

### BACKGROUND

### 1. Field of Art

This description generally relates to online content creation, and particularly to providing scores for component creatives included in online content items.

### 2. Description of the Related Art

Content providers produce content that is targeted to certain audiences within online systems. Users interact with content received from the online system. With the advent of online systems such as social networking systems, content providers have increasingly relied on the online systems to create effective sponsored content within the online system to greatly increase engagement among users of the online systems. For example, subsequent to presenting sponsored content provided by a content provider to users of an online system, the online system tracks how often the users interact with the presented content and calculates statistics for the content. These statistics may be accrued over numerous content campaigns and serve to measure the effectiveness of each content item in the campaign. Based on these statistics, the content provider can edit content items that perform poorly or alternatively choose to show content items that have performed very effectively.

Online systems can track the performance of previously published content items but provide zero or minimal feedback to content providers about the performance of particular components (e.g., text, images and videos) of a content item. Furthermore, current solutions for content creation do not provide error checking or recommendations to content providers during content creation. Thus, content providers face challenges in producing high quality content. For example, with current solutions, a content provider is not warned for a potentially undeliverable content on a selected online platform prior to delivering the content on the selected online platform.

Another challenge faced by the current solutions is that a content provider does not have a meaningful measurement of quality of each element of content for a target audience during content creation. For example, when using current solutions, content providers do not know if a particular image is popular among users in a target audience. If the particular image is not popular, then few users are likely to be interested in and interact with content including the particular image.

### SUMMARY

An online system provides scores for component creatives included in a content item to a content provider who creates the content item for a target audience. Various types of component creatives (also referred to as “creatives”) include, for example, images, videos, or text to be included in the content item. The score of a component creative indicates a likelihood that users of the online system, and particularly users of the target audience specified for the content item, will interact with the content item having the component creative. The online system trains a machine learning model to generate the scores. The model is trained using features based on previously published content items and interactions with the content items performed by users of the online system. Thus, the model learns which component creatives are more popular among users of a particular target audience. For example, one target audience prefers component creatives related to corgi dogs, while a different target audience prefers component creatives related to bulldogs. The online system can use image processing techniques to extract features from images for training the model. The scores are displayed inline on a graphical user interface while the content provider is creating the content items. Thus, the content provider is able to optimize the content item prior to submitting the content item for publishing.

In one embodiment, the online system receives content information describing previously published content items. The online system also receives user information and action information. The user information describes the users who interacted with the content items, e.g., demographic and geographical location information. The action information describes actions with the content items performed by the users, e.g., commenting, liking, or sharing a content item. The online system uses machine learning techniques to identify features based on the content items, the user information, and the action information. The online system generates a score for a creative to be included in a content item using a model trained based on the features. The online system presents the score to a content provider associated with the content item.

### BRIEF DESCRIPTION OF DRAWINGS

FIG. 1 is a block diagram of a system environment for providing recommendations of content items and creative scores according to one embodiment.

FIG. 2A is a block diagram of a creative data model according to one embodiment.

FIG. 2B shows a content item of the creative data model according to one embodiment.

FIG. 3 is a block diagram of an online system for providing recommendations of content items according to one embodiment.

FIG. 4A is a data flow diagram for training a creative score model according to one embodiment.

FIG. 4B is a diagram of feature sets for training creative score models according to one embodiment.

FIG. 5A shows a content creation user interface with creative scores, recommendations, and error notifications according to one embodiment.

FIG. 5B shows another content creation user interface according to one embodiment.

FIG. 6 is a flowchart illustrating a process for training a model to generate creative scores according to one embodiment.

FIG. 7 is a flowchart illustrating a process for providing inline recommendations of content items according to one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. System Overview

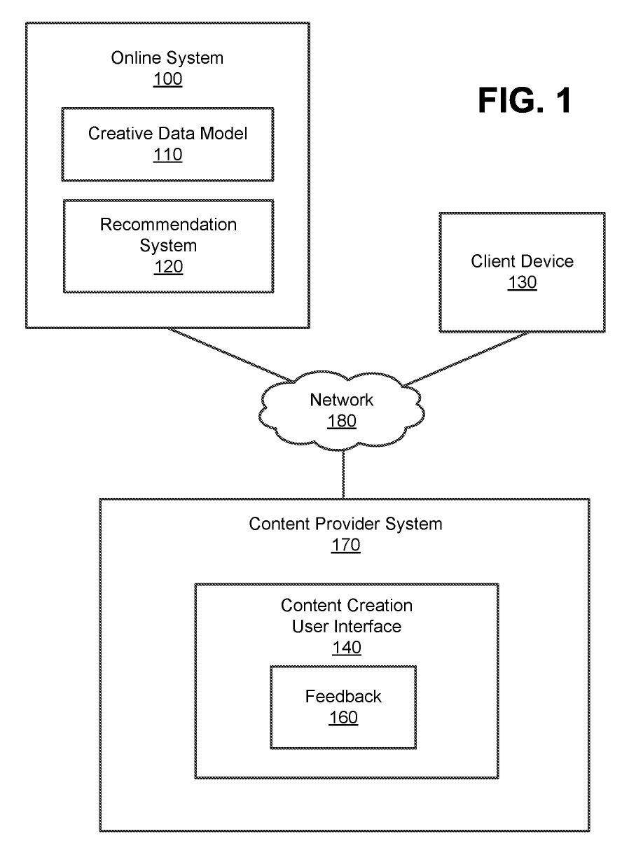

FIG. 1 is a block diagram of a system environment for providing recommendations of content items and creative scores according to one embodiment. The system environment includes an online system 100, a client device 130, and a content provider system 170 connected to each other over a network 180. In other embodiments, different and/or additional entities can be included in the system architecture.

The client device 130 is a computing device capable of receiving user input as well as transmitting and/or receiving data via the network 180. In one embodiment, a client device 130 is a conventional computer system, such as a desktop or laptop computer. Alternatively, a client device 130 may be a device having computer functionality, such as a personal digital assistant (PDA), a mobile telephone, a smartphone or another suitable device. A client device 130 is configured to communicate via the network 180. In one embodiment, a client device 130 executes an application allowing a user of the client device 130 to interact with the online system 100. For example, a client device 130 executes a browser application to enable interaction between the client device 130 and the online system 100 via the network 180. In another embodiment, a client device 130 interacts with the online system 100 through an application programming interface (API) running on a native operating system of the client device 130, such as IOS® or ANDROID™.

The content provider system 170 is used by content providers for interacting with the online system 100. In one embodiment, a content provider system 170 is an application provider communicating information describing applications for execution by a client device 130 or communicating data to client devices 130 for use by an application executing on the client device 130. In other embodiments, a content provider system 170 provides content or other information for presentation via a client device 130. For example, the content provider system 170 provides a third party website that communicates information to the online system 100, such as sponsored content or information about an application provided by the content provider. The sponsored content may be created by the entity that owns the content provider system 170. Such an entity may be a company (e.g., a third party outside of the online system 100) offering a product, service, or message that the company wishes to promote.

The network 180 includes any combination of local area and/or wide area networks, using both wired and/or wireless communication systems. In one embodiment, the network 180 uses standard communications technologies and/or protocols. For example, the network 180 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 180 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 180 may be represented using any suitable format, such as hypertext markup language (HTML) or extensible markup language (XML). In some embodiments, all or some of the communication links of the network 180 may be encrypted using any suitable technique or techniques.

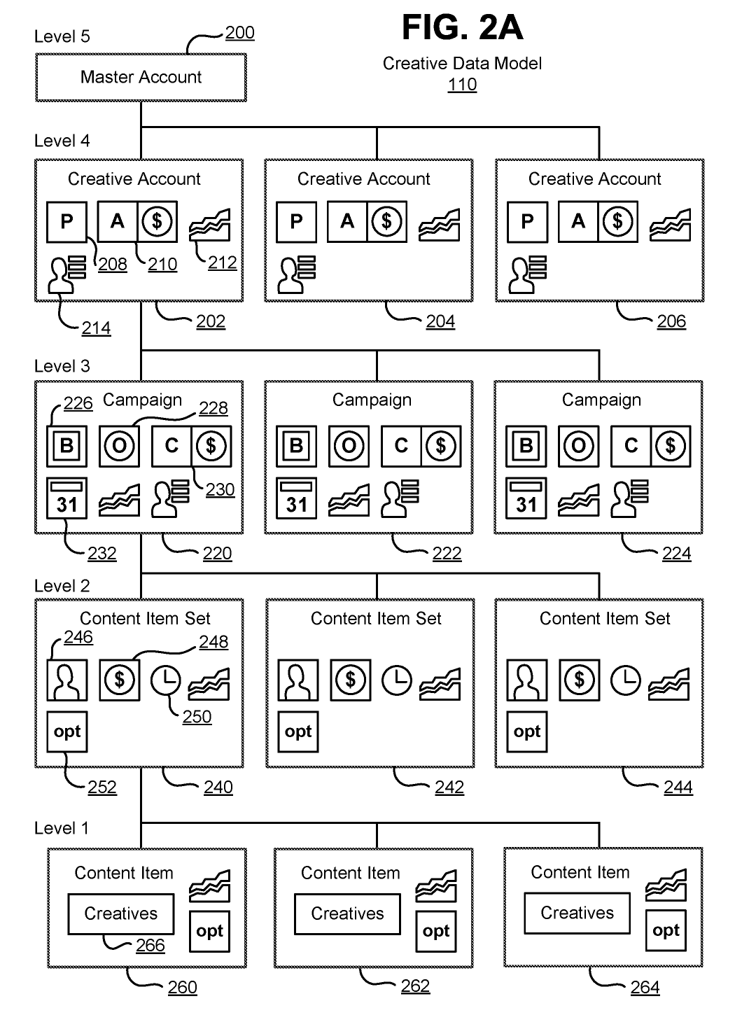

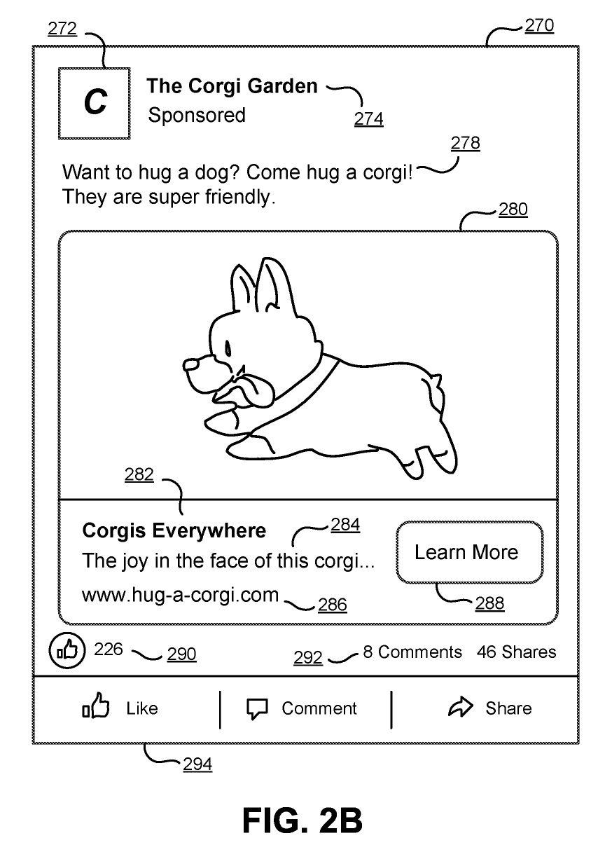

The online system 100 includes a computing environment that allows users of the online system 100 to communicate or otherwise interact with each other and access content. The online system 100 stores information about the users, for example, user profile information and information about actions performed by users on the online system 100. Further, the online system 100 includes a creative data model 110 and a recommendation system 120. The creative data model 110 (further described with reference to FIGS. 2A-B in Section II. Creative Data Model) is a hierarchal data structure that organizes information about content items including creatives that are used to generate content items, users of the online system 100 who create content items, accounts for the users, and target users for content items.

A content item is a combination of a number of component creatives; each component creative is a part of the content item to be created and presented to a target user, and each component creative is of a type. Examples of different types of creatives include images, photos, videos, bodies of text, call to actions (e.g., a call to action button), titles, and universal resource locators (URL). Images, photos, videos, or other types of graphical components may be referred to as media components. Based on the stored information about users and the creative data model 110, the online system 100 generates content items that a target user is likely to be interested in. The content items may include information provided by a creator of content items. The creator may be associated with the content provider system 170 and inputs information about content items to the online system 100 via the content creation user interface 140. The creator may also be a user of the online system 100. Based on the input information, the recommendation system 120 can provide different types of feedback 160 to the creator. The feedback 160 indicates, e.g., scores indicating a likelihood that users will be interested in and interact with the content items designed by the creator, as well as recommendations to improve the likelihood.

### II. Creative Data Model

FIG. 2A is a block diagram of a creative data model 110 according to one embodiment. In the embodiment illustrated in FIG. 2A, the creative data model 110 is a hierarchal model with five levels. Level 5 represents a master account 200, which may be associated with a content provider system 170. The master account 200 may be associated with one or more master creators who want to create and publish content items on the online system 100. The master creators may be, for example, owners or managers of a business. The master account 200 is associated with one or more creative accounts represented by level 4 of the creative data model 110, for example, creative accounts 202, 204, and 206. Each creative account can be associated with one or more other users (e.g., content item creators) of the online system 100. In some embodiments, a creative account is also associated with a master creator. A master creator can use the master account 200 to manage the associated creative accounts. For example, the master account 200 sets parameters of the associated creative accounts 202, 204, and 206, which is further described below.

A creative account is associated with one or more parameters. In particular, the creative account 202 is associated with one or more properties 208, an account spending cap 210, a reporting 212, and/or a set of rules and permissions 214. A property 208 represents an entity that can be described by one or more linked business objects, for example, a company brand, website, webpage, event, application, gift, product, and the like. The account spending cap 210 indicates a maximum budget (e.g., in United States Dollars) that the corresponding creative account can spend on publishing a number of content item sets on the online system 100, each of which has one or more content items. The maximum budget may be based on a duration of time (e.g., $1000 per month) or indicate a total budget available until completely used or expired after an expiration date. A reporting 212 describes metrics associated with published content items of the corresponding creative account. For example, the metrics indicate a budget spent on published content items over a duration of time, aggregate demographic information of users of the online system 100 who interact with the published content items, or a total number of views or clicks of the published content items. A set of rules and permissions 214 describes rules and permissions that the corresponding creative account must follow. For example, a rule indicates that a creative account can only publish one content item per day, a content item designed by a creative account must be approved by the corresponding master account before publishing, or the creative account can only publish content items to a certain target audience (e.g., based on demographic information).

A creative account may be associated with one or more campaigns represented at level 3 of the creative data model 110. In particular, creative account 202 is associated with campaigns 220, 222, and 224. A campaign is a collection of content item sets, i.e., associated with one or more content item sets represented by level 2 of the creative data model 110. In particular, campaign 220 is associated with content item sets 240, 242, and 244. A content item set is a collection of content items, i.e., associated with one or more content items represented by level 1 of the creative data model 110. In particular, content item set 240 is associated with content items 260, 262, and 264. Creators use campaigns and content item sets to organize content items, for example, based on factors including type of event, target audience (e.g., organized based on demographics or other types of information), time range (e.g., morning, afternoon, evening), size of budget, type of product, or type of online media.

In an example use case, a creator (e.g., business owner) of the creative account 202 generates the campaign 220 to promote a science fair, the campaign 222 to promote a school fundraiser, and the campaign 224 to promote a school basketball game. Further, for the campaign 220, the creator generates the content item set 240 to organize content items targeted to parents of students attending the science fair, the content item set 242 to organize content items targeted to sponsors of the science fair, and the content item set 244 to organize content items targeted to science and math teachers. The creator provides the creative 260 including a photo of an erupting volcano science fair project, the creative 262 including a photo of a robotic racecar science fair project, and the creative 264 including a photo of a chemistry experiment science fair project. In some embodiments, the creator provides the three photos to the creative data model 110 and the online system 100 dynamically selects which photo to use for a particular content item.

A campaign is associated with one or more parameters. In particular, the campaign 220 is associated with a business object 226, an objective 228, a campaign spending cap 230, a campaign duration 232, a reporting, and a set of rules and permissions. The reporting and a set of rules and permissions are substantially the same as the reporting 212 and a set of rules and permissions 214, but are applied at the campaign level (i.e., level 3) instead of the creative account level (i.e., level 4). The objective 228 indicates a purpose of the corresponding campaign. For instance, in the example use case described above, the objective 228 of the campaign 220 is to promote a science fair. Similar to the account spending cap 210, the campaign spending cap 230 indicates a maximum budget that the corresponding campaign can spend on publishing content items on the online system 100. The campaign duration 232 indicates a duration of time during which the corresponding campaign will publish content items.

A content item set is associated with one or more parameters. In particular, the content item set 240 is associated with an audience 246, budget 248, set schedule 250, reporting, and an optimization 252. The reporting is substantially the same as the reporting 212, but is applied at the content item set level (i.e., level 2) instead of the creative account level (i.e., level 4). The audience 246 indicates a target audience of users of the online system 100 for content items of the corresponding content item set. Following the same example use case described above, the audience 246 of content item set 240 is the group of parents of students attending the science fair. The audience 246 may be based on demographic information such as age and number of children, as well as other information such as geographical location (e.g., users living near the science fair). Similar to the account spending cap 210, the budget 248 indicates a maximum budget that the corresponding content item set can spend on publishing content items associated with the content item set on the online system 100. The set schedule 250 indicates times at which content items of the corresponding content item set are scheduled to be published. For example, the times indicate a time of day (e.g., mornings or 8-10 AM), a day of the week (e.g., Fridays or Saturdays), or a time pattern (e.g., the first Monday of each month).

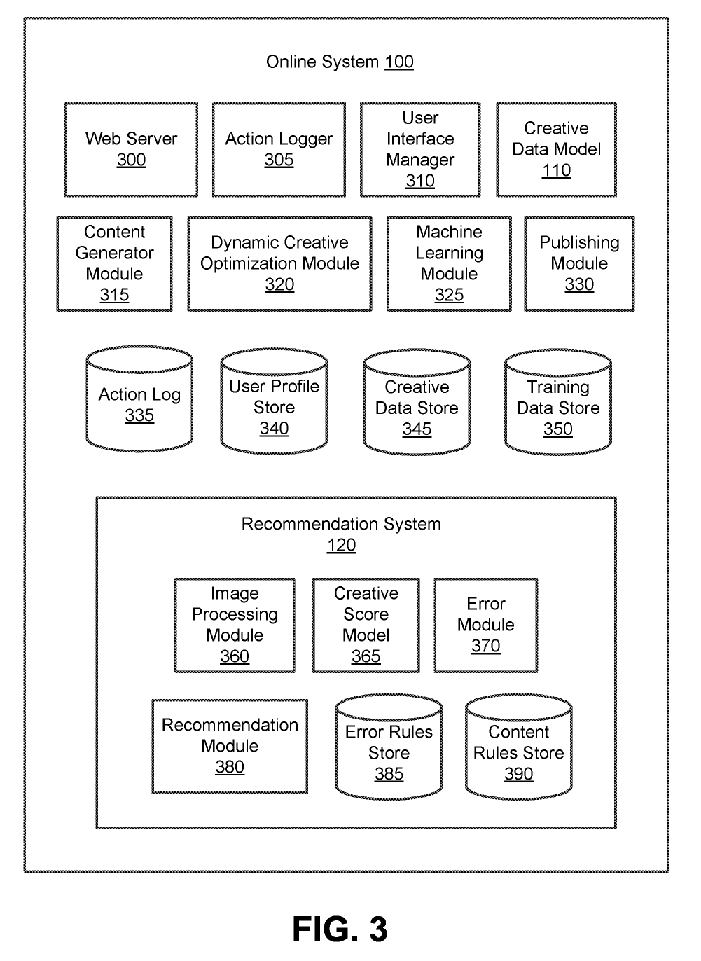

The optimization 252 indicates one or more optimizations that are used to increase the likelihood that a target user of the online system 100 will interact with a given content item of the corresponding creative set. For example, if the audience 246 describes target users as parents of students attending the science fair, then the optimization 252 indicates that selecting a photo of sample projects (e.g., a robotic racecar) is optimal, e.g., because the parents are more likely to be interested in the science fair if they view photos of sample projects. Accordingly, the parents are more likely to interact with the content item (including the photo of sample projects) to learn more about the science fair. Optimization of content items is further described below with reference to FIG. 3 in Section III. Recommendation System.

A content item includes one or more creatives and is associated with one or more parameters. In particular, the content item 260 includes creatives 266 and is associated with a reporting and an optimization, which are substantially the same as the reporting 212 and the optimization 252, but are applied at the content item level (i.e., level 1) instead of the creative account level (i.e., level 4) and the content item set level (i.e., level 2), respectively.

Though the creative data model 110 shown in FIG. 1 includes five levels, it should be noted that in other embodiments, creative data models may include additional levels, fewer levels, and/or different types of levels.

FIG. 2B shows a content item 270 of the creative data model 110 according to one embodiment. The content item 270 includes different types of creatives, e.g., images, photos, videos, bodies of text, call to actions, titles, and URLs. In particular, the content item 270 includes a logo 272, sponsor name 274, body of text 278, media 280, media title 282, creative subtext 284, creative URL 286, and call to action 288. Typically, a content item generated using one or more creatives, which can be provided by a creator using the online system 100. In the example shown in FIG. 2B, a publisher (e.g., a content provider system 170 that is a business or other type of organization) of the named “The Corgi Garden” designs the content item 270. Thus, the sponsor name 274 is the name of the publisher and the logo 272 is a logo of the publisher. The body of text 278 describes a service or product offered by the publisher, e.g., friendly corgi dogs to hug. The media 280 is an image and/or video associated with the publisher, e.g., a corgi dog. The media title 282 and the creative subtext 284 further describe the publisher. The creative URL 286 corresponds to a website of the publisher. The call to action 288 is a customizable button that calls for an action by the users of the online system 100. For example, the users can click the call to action 288 button to learn more about the publisher, share information about the content item 270, or purchase the publisher's service or product.

The content item 270 also includes engagement metrics about interactions performed by users of the online system 100 with the content item 270. For example, the metric 290 indicates how many users expressed interest in the content item 270 and the metrics 292 indicate how many comments about the content item 270 were posted by users and how many times users shared the content item 270 on the online system 100. Further, the content item 270 includes buttons 294 for the users to engage with the content item 270, e.g., buttons to express interest, post a comment, or share the content item 270.

### III. Online System

FIG. 3 is a block diagram of the online system 100 for providing recommendations of content items according to one embodiment. The online system 100 includes a web server 300, action logger 305, user interface manager 310, creative data model 110, content generator module 315, dynamic creative optimization module 320, machine learning module 325, publishing module 330, action log 335, user profile store 340, creative data store 345, training data store 350, and recommendation system 120. In other embodiments, the online system 100 may include additional, fewer, or different modules for various applications. Conventional components such as network interfaces, security mechanisms, load balancers, failover servers, management and network operations consoles, and the like are not shown so as to not obscure the details of the online system 100.

The web server 300 links the online system 100 via the network 180 to the one or more client devices 130 as shown in FIG. 1. The web server 300 serves web pages, as well as other web-related content, such as web-content written in JAVA®, FLASH®, XML and so forth. The web server 300 may receive and route messages between the online system 100 and the client device 130, for example, instant messages, queued messages (e.g., email), text messages, short message service (SMS) messages, or messages sent using any other suitable messaging technique. A user may send a request to the web server 300 to upload information (e.g., images or videos) that are stored in the user profile store 340. Additionally, the web server 300 may provide application programming interface (API) functionality to send data directly to native client device operating systems, such as IOS®, ANDROID™, WEBOS® or RIM®.

The user profile store 340 stores user profiles associated with each user of the online system 100. A user profile includes declarative information about the user that was explicitly shared by the user and may also include profile information inferred by the online system 100. In one embodiment, a user profile includes multiple data fields, each describing one or more attributes of the corresponding user of the online system 100. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 100 displayed in an image. A user profile in the user profile store 340 may also maintain references to actions by the corresponding user performed on the online system 100. The user profile store 340 further stores data describing one or more relationships between different users and allows users to specify their relationships with other users. For example, these user-defined relationships allow users to generate relationships with other users that parallel the user's real-life relationships, such as friends, co-workers, partners, and the like.

The user profile store 340 can store user profiles associated with individuals, as well as user profiles associated with entities such as businesses or organizations, e.g., that own a content provider system 170. This allows an entity to establish a presence on the online system 100 for connecting and exchanging content with other users of the online system 100. The entity may post information about itself, about its products, or provide other information to users of the online system 100 using a brand page associated with the entity's user profile. Users of the online system 100 may connect to the brand page to receive information posted to the brand page or to receive information from the brand page. A user profile associated with the brand page may include information about the entity itself, providing users with background or informational data about the entity.

The action logger 305 receives communications about user actions internal to and/or external to the online system 100, populating the action log 335 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 335.

The action log 335 may be used by the online system 100 to track user actions on the online system 100, as well as actions on third party systems that communicate information to the online system 100. Users may interact with various objects on the online system 100, and the action logger 305 stores information describing these interactions in the action log 335. Examples of interactions with objects include: commenting on posts, sharing links, and checking-in to physical locations via a mobile device, accessing content items, and any other interactions. Additional examples of interactions with objects on the online system 100 that are included in the action log 335 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 335 may record a user's interactions with sponsored content on the online system 100 as well as with other applications operating on the online system 100. In some embodiments, data from the action log 335 is used to infer interests or preferences of a user, augmenting the interests included in the user's user profile and allowing a more complete understanding of user preferences. The action log 335 can record information about client devices 130 that a user uses to interact with the online system 100. For example, the action log 335 records whether the user used a laptop computer or smartphone client device to interact with the online system 100. Further, the action log 335 may include information about the types of client devices 130, e.g., smartphone running an IOS® or ANDROID™ operating system.

The action log 335 may also store user actions taken on a content provider system 170, such as an external website, and communicated to the online system 100. For example, the external website may recognize a user of an online system 100 through a social plug-in enabling the external website to identify the user of the online system 100. Since users of the online system 100 are uniquely identifiable, external websites may communicate information about a user's actions outside of the online system 100 to the online system 100 for association with the user. Hence, the action log 335 can record information about actions that users perform on a content provider system 170 including webpage viewing histories, sponsored content that were engaged, purchases made, and other patterns from shopping and buying.

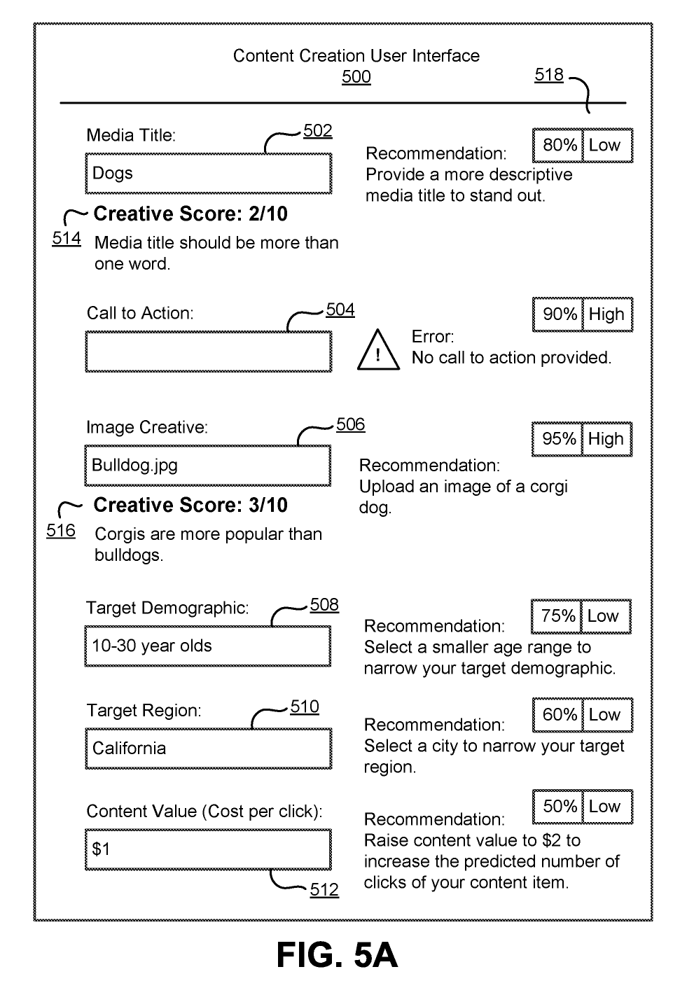

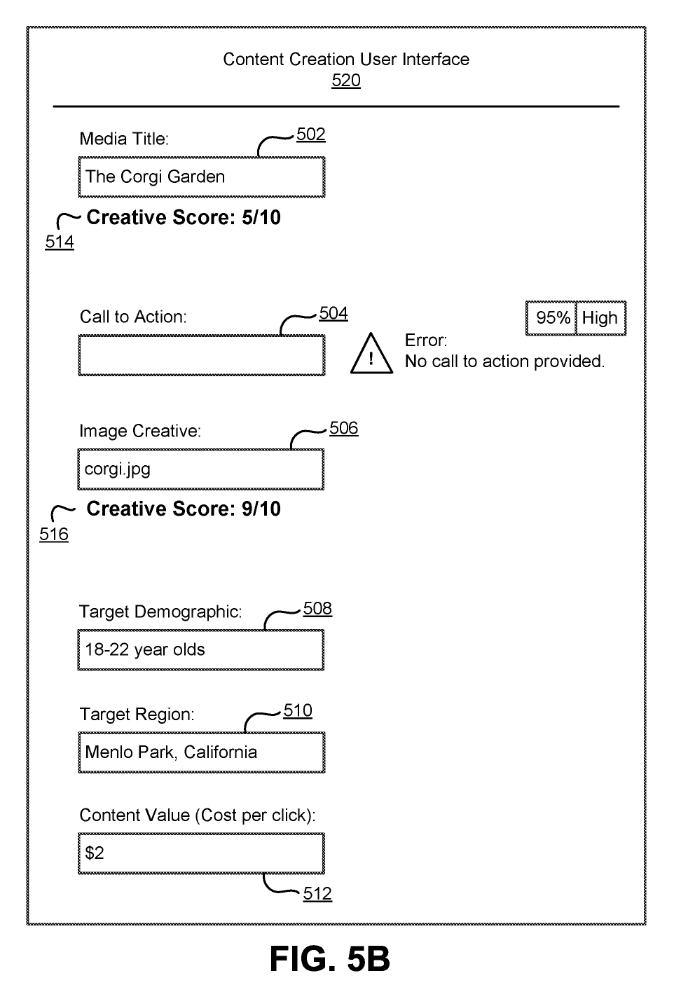

The user interface manager 310 generates graphical user interfaces presenting information from the online system 100. For example, a graphical user interface is the content creation user interface 140 shown in FIG. 1, and further described with reference to FIGS. 5A-B in Section V. Content Creation User Interface. Further, the graphical user interfaces can show content items, e.g., news feed stories, brand pages, sponsored content, etc., generated by the online system 100.

The content generator module 315 generates content items based on information from the creative data model 110, which is a hierarchal data structure that organizes information about content items, as previously described. The content generator module 315 publishes the generated content items for display on client devices 130 of users of the online system 100 and/or provides the generated content items for the content provider system 170 for publishing. In addition, the content generator module 315 can use information from the user profile store 340 or the action log 335 to generate content items. For example, the content generator module 315 retrieves information about a target user of the online system 100 from the user profile store 340 indicating the target user's demographics (e.g., age, gender, or ethnicity) or the target user's connections (e.g., indicating the target user's friends or family members in real life). Further, the content generator module 315 retrieves information about the target user from the action log 335 indicating the user's preferences based on actions performed by the user (e.g., certain brand pages that the target user liked or types of content items that the target user frequently interacts with). Based on the retrieved information, the content generator module 315 generates a content item that the target user is likely to interact with. In an example use case, the demographics indicate that the target user is a 25 year old male, and the target user's actions indicate that the target user is interested in basketball. Thus, the content generator module 315 generates a content item including content about basketball that has been viewed by many users of the online system 100 who are males in the 20-30 year old range.

The content generator module 315 can generate content items based on information about creatives stored in the creative data store 345. The creative data store 345 stores creatives, e.g., photos, videos, bodies of text, etc., provided by a content provider system 170 to the online system 100, e.g., via the content creation user interface 140. In some embodiments, the creative data store 345 stores creatives received by the online system 100 from other sources such as users of the online system 100 or a database of a creatives accessible on an online server, e.g., a database of photos of tourist travel destinations or a database of descriptions of a company's product. The content generator module 315 can store content items in the creative data store 345. Further, the content generator module 315 can retrieve the stored content items for publishing at a later time.

The dynamic creative optimization (DCO) module 320 optimizes content items based on information about creatives (e.g., from the creative data model 110 or creative data store 345) and users of the online system 100 (e.g., from the action log 335 or user profile store 340). In particular, the DCO module 320 dynamically selects certain creatives for use in a content item to increase the likelihood that a target user will interact with the content item. For instance, the DCO module 320 selects a photo of a vacation destination that many users have recently visited. The DCO module 320 is further described in U.S. application Ser. No. 15/199,386, filed on Jun. 30, 2016, which is hereby incorporated by reference herein in its entirety.

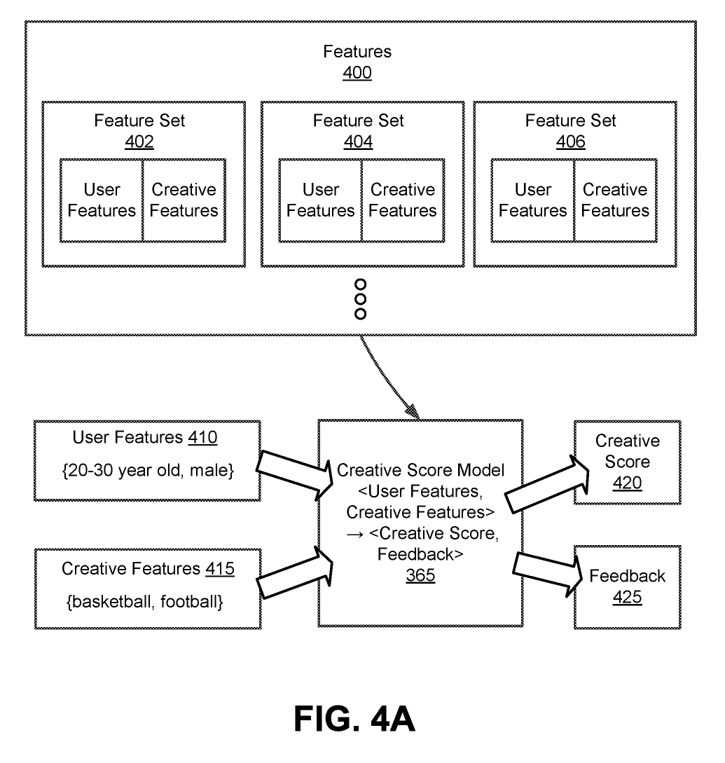

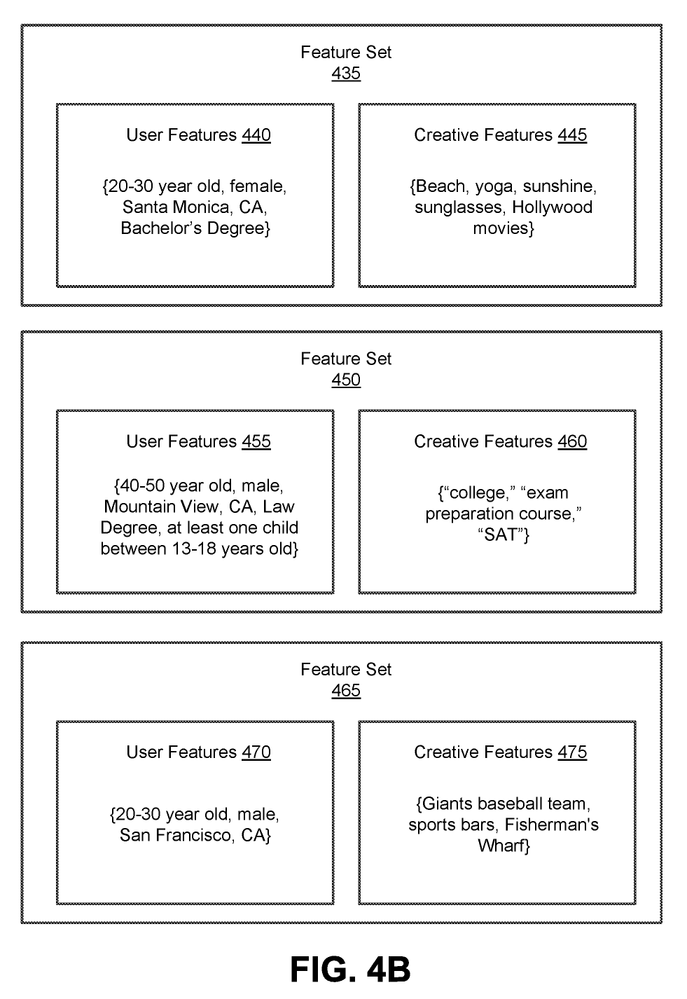

The machine learning module 325 trains one or more creative score models 365 using features based on training data from the training data store 350. The machine learning module 325 can store the creative score models 365 in the online system 100 and periodically re-train the creative score models 365 using features based on updated training data. Example features include demographics of target users, a geographic region of target users, a creative (e.g., an image, video, or text), or a content value. The features and the machine learning module 325 are further described below with reference to FIG. 4. In some embodiments, the training data store 350 includes predetermined information about a population of users of the online system 100 provided to the online system 100 or from another module of the online system 100, e.g., the action log 335 or user profile store 340.

The publishing module 330 selects content items to be published for display to users of the online system 100. In an example use case, the online system 100 detects a user logging into the online system 100 via a client device 130. The content generator module 315 identifies content items that are candidates (i.e., candidate content items) for display to the target user along with associated content values for each candidate content item. The content value of a candidate content item may have any suitable format for representing the compensation (e.g., monetary value) received by the online system 100 if the candidate content item is presented to the target user and/or if the target user interacts with the candidate content item. Different pricing models may be used to determine the content value, such as a cost-per-click (i.e., “CPC”) model where the content value is based on a per-user-interaction with the candidate content item, or a cost-per-impression (i.e., “CPI”) model where the content value is based on the number of times a candidate content item is presented. A content provider system 170 provides, to the online system 100, content values along with sponsored content information that the content provider system 170 wants to publish in content items, e.g., various types of creatives to be included in a candidate content item. The online system 100 receives more compensation by publishing content items including sponsored content associated with high content values. Thus, in a typical scenario, the publishing module 330 selects a first content item for publishing over a second content item if the content value of the first content item is greater than the content value of the second content item.

### IV. Recommendation System

The recommendation system 120 of the online system 100 generates and provides recommendations to modify content items to content creators, e.g., the content provider system 170, during the process of content items creation. In the embodiment illustrated in FIG. 3, the recommendation system 120 includes an image processing module 360, one or more creative score models 365, error module 370, recommendation module 380, error rules store 385, and content rules store 390.

The image processing module 360 extracts information from creatives that are images (also referred to as “image creative”). For example, the image processing module 360 analyzes an image creative and extracts a dominant color of the image, background color of the image, size of the image (e.g., width and length of the image), and a total number of image skin blobs. In one embodiment, the image processing module 360 uses image processing algorithms such as edge detection, Blob extraction, histogram analysis, pixel intensity filtering, gradient filtering, or scale-invariant feature transform to extract visual features of an image. Alternatively, the image processing module 360 applies an image feature extraction model to extract visual features of an image, e.g., to determine specific types of objects in the image such as a person, scenery, food, inanimate objects, etc. The image feature extraction model is trained using asynchronous stochastic gradient descent procedures or a variety of distributed batch optimization procedures on computing clusters a large corpus of training images.

The creative score model 365 generates creative scores for creatives of a content item. The creative score indicates the quality of a creative. In one embodiment, the creative score of a creative indicates the likelihood that the online system 100 will publish a content item including the creative. In another embodiment, the creative score of a creative indicates the likelihood that users will interact with the content item having the creative after being published. The creative score model 365 may generate the creative scores based on rules from the content rules store 390, information extracted by the image processing module 360, or information from other modules of the online system 100, e.g., the creative data model 110 or the error module 370 (further described below). In some embodiments, the online system 100 includes multiple creative score models 365, for example, each corresponding to a different type of creative (e.g., image or video or body of text). The machine learning module 325 trains each creative score model 365 using features based on creatives and/or content items including creatives of the corresponding type. The creative score model 365 can provide creative scores for display to a creator in a content creation user interface 140. The creative score model 365 can also combine creative scores for multiple creatives (included in a content item) to generate an aggregate creative score for the content item. For example, the creative score model 365 combines creative scores using a weighted average function. The creative score model 365 may weigh certain types of creatives more than other types of creatives, e.g., an image is weighed more heavily than a URL. The rules and creative score model 365 are further described with reference to FIG. 4 and FIGS. 5A-B in Section V. Content Creation User Interface.

The error module 370 generates error notifications associated with content items during the creation process of the content items. The error module 370 generates the error notifications based on error rules from the error rules store 385. For instance, an error rule indicates that a “missing creative” error notification should be generated if a content item is missing one or more different types of creatives, e.g., the content item is missing a creative name or creative media. The error module 370 can provide error notifications inline for display to a creator in a content creation user interface 140.

In some embodiments, the online system 100 saves partially generated content items based on information input via a content creation user interface 140 by a creator even if there are error notifications generated by the error module 370, and thus violating one or more rules. Further, the online system can save completed content items that still have errors. The online system 100 can store the input information in the creative data store 345. In an example use case, the content generator module 315 generates a temporary content item, e.g., an in-progress draft, based on the input information (e.g., creatives and target user information) provided by the content provider. The content generator module 315 can store the temporary content item in the creative data store 345 and retrieve previously stored temporary content items from the creative data store 345. The temporary content item does not necessarily need to be complete, e.g., the temporary content item is missing certain creatives or can be further optimized based on recommendations. Thus, the content generator module 315 does not publish temporary content items. The creator can return to the content creation user interface 500 at a later time to correct the errors or continue designing a temporary content item without losing previously completed progress, e.g., creatives that the creator previously provided for the temporary content item. Additionally, a different creator associated with the content provider system 170 can also work on a previously saved temporary content item in progress. Once a temporary content item is completed or submitted for publishing, the content generator module 315 converts the temporary content item to a regular content item.

The error rules store 385 can include error rules associated with different types of errors such as soft errors (e.g., a warning) and critical errors, which prevent a generated content item from being published. The content generator module 315 can generate a content item even if the content item still has an unfixed soft error (e.g., missing a creative text). In contrast, the content generator module 315 does not publish a content item if the content item still has an unfixed critical error (e.g., missing a content value).

As an example, an error notification indicates that the online system 100 may not publish a content item on a certain platform because the content item is missing a media type creative (e.g., an image or a video). In this case, a creator can select a different platform to publish the content item, or fix the issue by providing the missing creative. Certain platforms or channels for publishing can be associated with specific types of error rules. For example, a soft error rule indicates that content items published on the INSTAGRAM® channel in particular should have a square shaped image creative. As another example, an error notification indicates that the creator will have to provide additional compensation to the online system 100 to publish a content item because the content item violates a corresponding error rule, e.g., a body of text of the content item including more than a upper threshold number of words or less than a lower threshold number of words. The online system 100 can use optical character recognition (OCR) techniques to determine the number of words in the body of text. The error rules and error module 370 are further described with reference to FIGS. 5A-B in Section V. Content Creation User Interface.

The recommendation module 380 generates recommendations to modify content items. Similar to the creative score model 365, the recommendation module 380 may generate recommendations based on rules from the creative rules store 390 or information from other modules of the online system 100. For example, if a content item has a broad creative name, the recommendation module 380 generates a recommendation suggesting that a creator (e.g., associated with a content provider system 170) who is designing the content item should provide a more descriptive media title, e.g., adding additional words such as adjectives to the media title. In another example, a content item has a target audience of users that is too broad, e.g., the target region of the United States includes 150 million users. A rule indicates that the recommended threshold value of users is 100 million users. Since 150 million is greater than the threshold, the recommendation module 380 generates a recommendation suggesting that the creator should provide additional information to narrow the target audience, e.g., indicating a particular state or city in the United States. If the creator modifies a content item based on the corresponding recommendations, an updated creative score of the content item will be greater than the previous creative score.

The recommendation module 380 can provide inline recommendations for display to a creator in a content creation user interface 140. The recommendation module 380 can also generate a confidence score indicating how likely a recommendation is applicable to the content item, as well as an importance score indicating the importance of the recommendation to the content item. In other words, a greater confidence score indicates that if the creator modifies a creative of a content item based on the corresponding recommendation, then there is a higher likelihood that the creative score model 365 will generate an updated creative score for the creative, which, in turn, is likely to increase the likelihood of the content item being published. In addition, a greater importance score indicates that if the creator modifies a creative of the content item based on the corresponding recommendation, then the creative score model 365 will generate an updated creative score with a greater difference in magnitude (typically a greater score) compared to the previous creative score. The recommendation module 380 is further described below with reference to FIGS. 5A-B in Section V. Content Creation User Interface.

FIG. 4A is a data flow diagram for training the creative score model 365 according to one embodiment. The machine learning module 325 retrieves training data from the training data store 350 and extracts features 400 from the training data. The machine learning module 325 trains the creative score model 365 using the features 400. The training data includes information about creatives and content items published by the online system 100 (e.g., from the content generator module 315 or the creative data store 345) and information about users of the online system 100 who interacted with the published creatives and content items (e.g., from the action log 335 or user profile store 340). The features 400 include one or more feature sets, e.g., feature sets 402, 404, and 406. Each feature set includes a set of user features and a set of creative features. Though only three feature sets are shown in FIG. 4A, in practice, the machine learning module 325 trains the creative score model 365 using many more feature sets, for example, including hundreds of different user features and thousands of different creative features.

The creative score model 365 is associated with a creative type, e.g., image creative, video, or creative subtext. In the example shown in FIG. 4A, the creative score model 365, associated with image creatives, takes as input user features 410 and creative features 415. The user features 410 describe a target user who will be presented with a content item. The creative features 415 describe an image creative of a content item that may be presented to the target user. Based on the input, the creative score model 365 generates a creative score 420 and accompanying feedback 425 for the creative in the context of the target user. For instance, the user features 410 indicate that the target user is a 20-30 year old male user. The creative features 415 indicate that the image creative includes an image of a basketball and a football (e.g., based on image processing techniques). In some embodiments, the creative features 415 indicate a content value of a previously published content item including the image creative or similar image creatives. Based on features from previous training data, the creative score model 365 determines that 20-30 year old male users have a strong affinity for basketball and football. Thus, the creative score model 365 generates a high creative score 420 indicating that the target user is likely to interact with the image creative. The creative score model 365 may also determine that 20-30 year old male users have a strong affinity for baseball. Thus, the feedback 425 indicates that including an image of a baseball in the image creative may result in a greater creative score 420.

In some embodiments, the creative features 415 describe information extracted by the image processing module 360 from an image creative. To generate features to train the creative score model 365, the machine learning module 325 can compare the extracted information with other extracted information from reference creatives. For example, the reference creatives include reference image creatives associated with a high click through rate. In other words, users frequently interacted (e.g., click on a corresponding URL or call to action button) with previously published content items including the reference image creatives. The extracted information from the reference image creatives indicates that the reference image creatives include, on average, two to five people (e.g., a photo of people socializing at a birthday party) because the image processing module 360 uses a human face or eye detection algorithm to identify the number of people in the reference image creatives. The creative score model 365 determines that if the extracted information indicates that the corresponding image creative also includes two to five people (similar to the reference image creatives), then a content item including the image creative may also likely have a high click through rate. Thus, the creative score model 365 generates a greater creative score for content items including the image creative or other similar image creatives. To train creative score models 365 associated with other types of creatives, the machine learning module 325 uses a similar process to generate creative features. For example, the machine learning module 325 uses natural language processing techniques on body of texts or creative subtexts to determine keywords, phrases, or hashtags, and the like, that frequently appear in content items that are popular among a group of target users.

FIG. 4B is a diagram of feature sets for training creative score models according to one embodiment. Feature set 435 includes user features 440 and creative features 445. The user features 440 indicate that a group of target users include users who are 20-30 year old females who live in Santa Monica, Calif. and earned a Bachelor's degree. The creative features 445 indicate that the group of target users frequently interact with content items including image creatives with images of a beach, yoga, sunshine, sunglasses, or Hollywood movies, e.g., because the target users have a strong affinity for the visiting the beach, performing yoga, going outdoors in the sunshine, purchasing sunglasses, or watching Hollywood movies.

Feature set 450 includes user features 455 and creative features 460. The user features 455 indicate that a group of target users include users who are 40-50 year old males who live in Mountain View, Calif. earned a law degree, and have at least one child between 13-18 years old. The creative features 460 indicate that the group of target users frequently interact with content items including body of text type creatives with the keywords “college,” “exam preparation course,” and/or “SAT,” e.g., because the target users are likely interested in helping their child find exam preparation courses to study for the SAT exam and apply for college.

Feature set 465 includes user features 470 and creative features 475. The user features 470 indicate that a group of target users include users who are 20-30 year old males who live in San Francisco, Calif. The creative features 475 indicate that the group of target users frequently interact with content items including image creatives with images of the Giant's baseball team, sports bars, and Fisherman's Wharf, e.g., because the target users have a strong affinity for attending Giant's baseball games, visiting sports bars, and visiting Fisherman's Wharf in San Francisco.

As the machine learning module 325 trains the creative score model 365 over time using different sets of features, the creative score model 365 can recognize which types of creatives, when included in a given content item, are likely to result in a greater number of interactions performed by target users with the given content item. As illustrated by the feature sets 435, 450, and 465, different types of target users are more interested in certain types of creatives than others. Thus, a creative score model 365 trained using the feature sets 435, 450, and 465 would generate a low creative score for input user features 440 and creatives features 460 because most 20-30 year olds who have earned a Bachelor's Degree have already taken the SAT exam and graduated from college.

### V. Content Creation User Interface

FIG. 5A shows a content creation user interface 500 with creative scores, recommendations, and error notifications according to one embodiment. The content creation user interface 500 (e.g., an embodiment of the content creation user interface 140 shown in FIG. 1), generated by the user interface manager 310 (shown in FIG. 3), includes input forms (e.g., a text box, drop down menu, radio buttons, file upload button, etc.) for a creator to provide creatives to the online system 100. In particular, the content creation user interface 500 includes the input form 502 for a media title, input form 504 for a call to action, input form 506 for an image creative, input form 508 for a target demographic, input form 510 for a target region, and input form 512 for a content value. In other embodiments, the content creation user interface 500 includes input forms corresponding to other information used to generate or publish the content item, e.g., a total budget for publishing the content item, a certain platform (or channel) for publishing the content item (e.g., INSTAGRAM®), a certain type of client device 130 (e.g., a mobile smartphone or a laptop computer) to display the published content item, a logo, a creative subtext, creative URL, etc. The content creation user interface 500 can also include creative scores generated by the creative score model 365 for each creative provided by a creator, recommendations generated by the recommendation module 380, and error notifications generated by the error module 370.

In the embodiment shown in FIG. 5A, a creator who is associated with a content provider system 170 creates a content item using the content creation user interface 500. The creator inputs “Dogs” for the media title, an image file of a bulldog named “bulldog.jpg” for the image creative, “10-30 year olds” as the target demographic, “California” as the target region, and “$1” as the content value. Creative score models 365 generate the creative score 514 for the media title and the creative score 516 for the image creative. The creative scores along with feedback are generated in real time and displayed on the content creation user interface 500 while the creator is creating the content item. Thus, the creator is informed if the content item in progress has creatives with low quality and can make modifications to improve the quality of the creatives to be included in the content item when published.

A first creative score model 365 is trained to generate scores for media title type creatives. The first creative score model 365 takes as input creative features of the media title “Dog” and user features describing the target demographic “10-30 year olds” and the target region “California.” Based on the input, the first creative score model 365 outputs the creative score 514 of “2/10,” e.g., two points out of a total of ten points, where points are values and a greater point value indicates that users of the online system 100 are more likely to interact with a content item with the corresponding media title. The creative score 514 is low because media titles that are more descriptive and have more than one word are typically correlated with more interactions from users, e.g., based on features from previously published content items with media titles. Further, users who are in the 10-30 year old range located in California may be most interested in a first breed of dog (e.g., Corgis), and users of a different age range and/or region may be most interested in a second breed of dog (e.g., Siberian Husky). Thus, the media title does not provide sufficient granularity to distinguish between the two preferred breeds of dogs. A more descriptive media title that would have a greater creative score may be “How to exercise with your corgi” or “Tricks to teach your Siberian husky.” Accordingly, the first creative score model 365 also generates the feedback “media title should be more than one word” for display on the content creation user interface 500.

A second creative score model 365 is trained to generate scores for image creatives. The second creative score model 365 takes as input creative features describing the image creative “bulldog.jpg” and user features describing the target demographic “10-30 year olds” and the target region “California.” Based on the input, the second creative score model 365 outputs the creative score 516 of “3/10.” The creative score 516 is low, for example, because the second creative score model 365 determines that users who are 10-30 years old and located in California are more interested in corgi dogs relative to bulldogs. The second creative score model 365 makes the determination based on features used during training. For instance, the features indicate that users interact more frequently with previously published content items including image creatives of corgis than previously published content items including image creatives of bulldogs. Accordingly, the second creative score model 365 also generates the feedback “corgis are more popular than bulldogs” for display on the content creation user interface 500.

The content creation user interface 500 shows the recommendation “provide a more descriptive media title to stand out” because the media title “Dogs” is too broad (e.g., the creative title only includes one word without any adjectives or other descriptions), and thus unlikely to capture the attention of users of the input target demographic and target region. The content creation user interface 500 shows the error notification “no call to action provided” because the creator did not input a call to action (e.g., an “install now,” “purchase,” or “learn more” call to action button). The content creation user interface 500 shows the recommendation “upload an image of a corgi dog” because corgi dogs are more popular than bulldogs for user of the input target demographic and target region. The content creation user interface 500 shows the recommendation “select a smaller age range to narrow your target demographic” because the age range “10-30 year olds” is too wide, e.g., a 10 year old user may not likely be interested in the same types of content items or creatives as a 30 year old user. The content creation user interface 500 shows the recommendation “select a city to narrow your target region” because the region “California” is too board, e.g., a user located in San Francisco, Calif. may not likely be interested in the same types of content items or creatives as a user located in Fresno, Calif.

The content creation user interface 500 shows the recommendation “raise content value to $2 to increase the predicted number of clicks of your content item” because the average content value of content items that 10-30 year old users in California frequently interact with is $2, which is greater than $1. The publishing module 330 will generally select content items with a content value of $2 to publish rather than the content item with a content value of $1. Thus, increasing the content value to $2 increases the probability that the publishing module 330 will select the content item, and thus result in a greater number of predicted clicks (also referred to as “click through rate”) of the content item. In some embodiments, the error module 370 generates a warning or critical error notification if the content value is too low.

The content creation user interface 500 shown in FIG. 5A shows feedback 518, e.g., a confidence score and importance score for each of the recommendations and error notifications generated by the recommendation module 380. The confidence scores for the recommendations associated with the media title, media, target demographic, target region, and content value are 80%, 95%, 75%, 60%, and 50%, respectively. The confidence score for the error notification associated with the call to action is 90%. Based on the confidence scores, the creative score model 365 is most likely to generate an updated creative score for the image creative if the creator modifies the image creative according to the feedback provided because the high confidence score indicates that the recommendation associated with the call to action is highly applicable to the creative call to action. Though the confidence scores are shown as a percentage, it should be noted that in other embodiments, the confidence scores can be represented in other forms, e.g., an integer value or a letter grade such as A, B, C, D, or F.

The importance scores for the recommendations associated with the media title, target demographic, target region, and content value are all “low.” The importance scores for the error notification associated with the call to action and the recommendation associated with the image creative are both “high.” In the example shown in FIG. 5A, a high importance score is more important than a low importance score associated with a recommendation for a creative. Thus, if the creator modifies the creatives with “high” importance scores according to the corresponding feedback, the updated creative score for the creatives will most likely increase, compared to the updated creative score if the creator modifies the creatives with “low” importance scores. Though the importance scores are shown as a string (i.e., “high” or “low”), it should be noted that in other embodiments, the confidence scores can be represented in other forms, e.g., an integer value or percentage. Further, the importance score can indicate additional granularity, e.g., “very high,” “high,” “medium,” “low,” and “very low.” Similar to the recommendation module 380, the error module 370 can also generate feedback in the form of confidence scores and importance scores for each of the errors. Similar to the creative scores, the recommendations, confidence scores, and importance scores are generated in real time and displayed inline on the content creation user interface 500 while the creator is creating the content item. Thus, the creator can review the recommendations and scores to make suitable modifications to the content item.

FIG. 5B shows another content creation user interface 520 according to one embodiment. The content creation user interface 520 is an embodiment of the content creation user interface 500 shown in FIG. 5A. However, the input information is different between the two content creation user interfaces. The creator—who used the content creation user interface 500 to design the content item—provided additional information and modified previously input information about the content item. Since the recommendations, error notifications, and creative scores (e.g., feedback) are displayed inline in the content creation user interface 500, the creator is able to review the feedback and modify the content item prior to submitting the content item for publishing. By modifying the content item, the creator can optimize the content item to increase the probability that more users will interact with the content item. The creator modified the media title from “dogs” to “The Corgi Garden.” The creator provided a new image creative, e.g., the image file named “Corgi.jpg” that includes a photo of a corgi dog. The creator modified the target demographic from the age range “10-30 year olds” to the age range “18-22 year olds.” The creator modified the target region from “California” to “Menlo Park, Calif.” The creator modified the content value from $1 to $2.

Following in the same example use case described with reference to FIG. 5A, the first creative score model 365 generates the updated creative score 514 of “5/10” for the media title. The updated content score 514 is greater than the content score 514 of “2/10” shown in the content creation user interface 500 because the creator modified the media title based on the feedback shown in the content creation user interface 500. Specifically, the creator provided a more descriptive media title that has more than one word and is related to corgis, which is a popular breed of dog among 18-22 year olds in Menlo Park, Calif., compared to bulldogs. Thus, compared to a content item including the media title “Dog,” a content item including the media title “The Corgi Garden” is more likely to be interacted with by users of the online system 100.

The second creative score model 365 generates the updated creative score 516 of “9/10” for the image creative. The updated content score 516 is greater than the creative score 516 of “3/10” shown in the content creation user interface 500 because the creator modified the image creative based on the feedback shown in the content creation user interface 500. Specifically, the creator provided an image creative of a corgi, which is a popular breed of dog among 18-22 year olds in Menlo Park, Calif., compared to bulldogs. Thus, compared to a content item including the image creative “bulldog.jpg,” a content item including the image creative “corgi.jpg” is more likely to be interacted with by users of the online system 100.

### VI. Process Flows

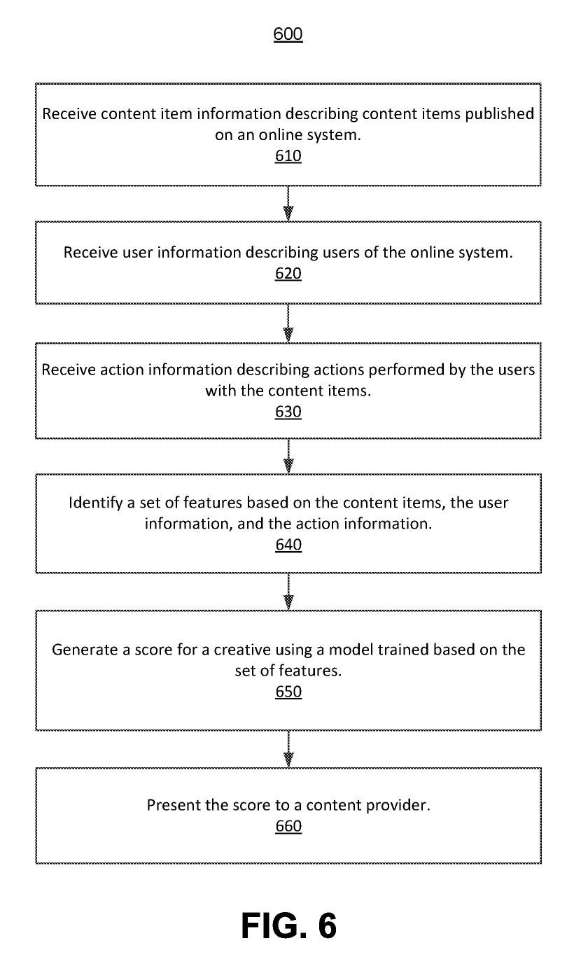

FIG. 6 is a flowchart illustrating a process 600 for training a model to generate creative scores according to one embodiment. In some embodiments, the process 600 is used by the online system 100—e.g., modules of the online system 100 described with reference to FIG. 3—within the system environment in FIG. 1. The process 600 may include different or additional steps than those described in conjunction with FIG. 6 in some embodiments or perform steps in different orders than the order described in conjunction with FIG. 6.

The recommendation system 120 receives 610 content information describing content items previously published, e.g., displayed on client devices of users of an online system 100. Each content item includes at least one creative. The creative may be an image creative, media title, body of text, call to action, or another type of creative. The recommendation system 120 receives 620 user information and receives 630 action information, e.g., from the action log 335 or the user profile store 340. The user information describes the users, e.g., demographic and geographical region information of the users. The action information describes actions with the content items performed by the users on the online system 100, e.g., viewing an image creative or media, clicking a URL of a content item, commenting on a content item, or sharing a content item. The machine learning module 325 identifies 640 feature sets based on the content items, the user information, and the action information. For example, the machine learning module 325 extracts feature sets (e.g., feature sets 435, 450, and 465 shown in FIG. 4B) including user features and creative features. The recommendation system 120 generates 650 a score for a creative (e.g., an image type creative or a body of text type creative) to be included in a content item using a model, e.g., the creative score model 365, trained based on the feature sets. The creative score indicates the likelihood that the users will interact with a content item including the creative. The online system 100 presents 660 the score to a content provider associated with the content item, e.g., a content provider of the content provider system 170 who is creating the content item using the content creation user interface 140. The machine learning module 325 can store the creative score model 365 in the online system 100 and may periodically re-train the creative score model 365 using new feature sets over time.

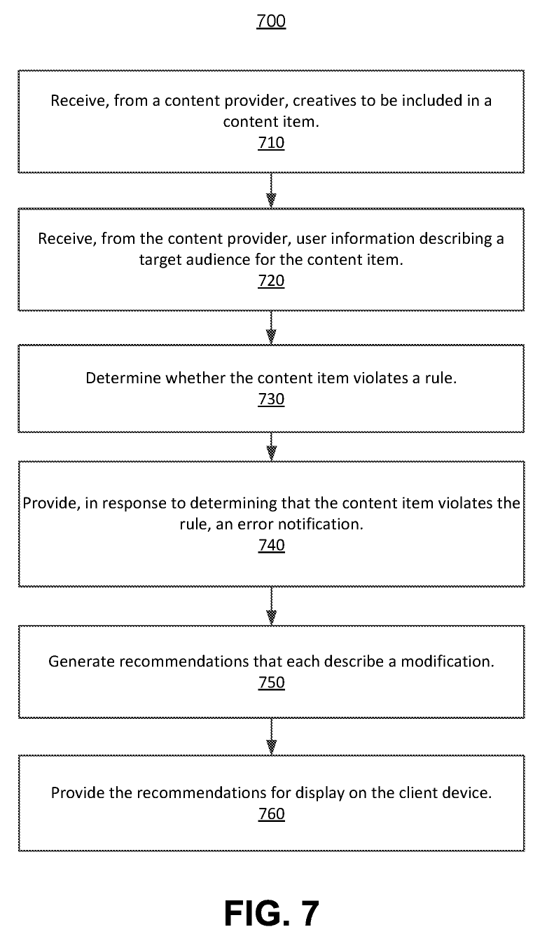

FIG. 7 is a flowchart illustrating a process 700 for providing recommendations of content items according to one embodiment. In some embodiments, the process 700 is used by the online system 100—e.g., modules of the online system 100 described with reference to FIG. 3—within the system environment in FIG. 1. The process 700 may include different or additional steps than those described in conjunction with FIG. 7 in some embodiments or perform steps in different orders than the order described in conjunction with FIG. 7.

The user interface manager 310 provides 710 a graphical user interface (e.g., the content creation user interface 500 shown in FIG. 5A) to a content provider (e.g., content provider system 170 shown in FIG. 1). The graphical user interface is used by the content provider to create a content item for a target audience. The recommendation system 120 receives 720 creatives to be included in the content item from the content provider. For example, the recommendation system 120 receives content item information including parameters associated with the creatives. The creatives can include one or more different types of creatives, e.g., a logo, sponsor name, body of text, image creative, media, creative subtext, creative URL, or call to action. The recommendation system 120 receives 730 user information from the content provider. The user information describes the target audience for the content item, where the target audience includes users of the online system 100. The error module 370 determines 740 whether the content item violates a rule (e.g., from the error rules store 385) on content item creation based on one of the creatives and/or the user information. In response to determining that the content item does violate a rule, the error module 370 provides 750 an error notification for display on the graphical user interface. For instance, the content creation user interfaces 500 or 520 shown in FIGS. 5A-B display the error notifications inline in real time while the creator is creating the content item. The error notification indicates to the content provider that the content item being created violates the rule. Also in response to the rule violation, the recommendation module 380 generates 760 recommendations that each describe a modification associated with at least one of the creatives and the user information. The recommendation module 380 provides 770 the recommendations for display on the client device 130 of the content provider system 170. For instance, the content creation user interfaces 500 or 520 shown in FIGS. 5A-B display the recommendations inline in real time while the creator is creating the content item. The content generator module 315 generates 780 the content item for display to the target audience.

In some embodiments, the online system 100 does not necessarily provide the error notifications and the recommendations on the graphical user interface. For example, the online system 100 can provide the error notifications and/or the recommendations via an API call from the client device of the content provider.

### VII. General

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable non-transitory medium containing computer program code, which can be executed by a computer processor for performing any or all of the steps, operations, or processes described.

Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, by an online system, content item information describing a plurality of content items previously displayed on client devices of users of the online system, each content item including a plurality of creatives;
receiving user information describing the users;
receiving action information describing actions with each of the plurality of content items performed by the users on the online system;
identifying a set of features based on the plurality of content items, the user information, and the action information;
receiving, by the online system from a content provider, one or more creatives to be included in a content item being created by the content provider for a target audience specified by the content provider;
generating a score for each of the one or more creatives to be included in the content item for the target audience using a model trained based on the set of features that indicate popularity of different creatives with users in the target audience, each score indicating a likelihood that the target audience will interact with the content item including the corresponding creative; and
presenting, before the content item is displayed to the target audience, the scores for the one or more creatives to the content provider associated with the content item for the target audience.

2. The method of claim 1, further comprising re-training the model using a new set of features based on a new plurality of content items and new action information describing actions with each of the new plurality of content items performed by the users on the online system.

3. The method of claim 1, wherein the model is further configured to generate, for a creative, feedback associated with the score describing at least one feature of the set of features.

4. The method of claim 1, further comprising:
receiving, from the content provider, a first candidate creative image for the content item for the target audience;
receiving, from the content provider, user information describing the target audience for the first candidate creative image, the target audience including a target plurality of users of the online system;
providing the first candidate creative image and the user information as input to the model;
generating, by the model, a first score for the first candidate creative image; and
providing the first score for display on a client device of the content provider.

5. The method of claim 4, further comprising:
receiving, from the content provider, a second candidate creative image for the content item for the target audience;
providing the second candidate creative image and the user information as input to the model;
generating, by the model, a second score for the second candidate creative image; and
providing the second score for display on the client device of the content provider.

6. The method of claim 5, further comprising:
responsive to the second score being higher than the first score, providing to the content provider a recommendation on which candidate creative image should be included in the content item for the target audience.

7. The method of claim 1, wherein the user information describes demographic information and geographical region information of the users.

8. The method of claim 1, wherein the actions include at least one of: viewing a media of a content item, clicking a URL of a content item, liking a content item, commenting on a content item, and sharing a content item.

9. The method of claim 1, wherein the content information describes at least, for each content item of the plurality of content items, a content value indicating a compensation that the online system receives for providing the content item for display on the client devices.

10. The method of claim 1, wherein identifying the set of features further comprises:
identifying a reference creative image of a content item of the plurality of content items; and
extracting an image feature from the reference creative image, wherein the set of features includes the image feature.

11. The method of claim 1, further comprising storing the model in the online system.

12. A computer program product comprising a non-transitory computer readable storage medium having instructions encoded thereon that, when executed by a processor, cause the processor to:
receive, by an online system, content item information describing a plurality of content items previously displayed on client devices of users of the online system, each content item including a plurality of creatives;
receive user information describing the users;
receive action information describing actions with each of the plurality of content items performed by the users on the online system;
identify a set of features based on the plurality of content items, the user information, and the action information;
receive, by the online system from a content provider, one or more creatives to be included in a content item being created by the content provider for a target audience specified by the content provider;
generate a score for each of the one or more creatives to be included in the content item for the target audience using a model trained based on the set of features that indicate popularity of different creatives with users in the target audience, each score indicating a likelihood that the target audience will interact with the content item including the corresponding creative; and
present, before the content item is displayed to the target audience, the score for the creative to a content provider associated with the content item for the target audience.

13. The non-transitory computer readable storage medium of claim 12, having further instructions that when executed by the processor cause the processor to re-train the model using a new set of features based on a new plurality of content items and new action information describing actions with each of the new plurality of content items performed by the users on the online system.

14. The non-transitory computer readable storage medium of claim 12, wherein the model is further configured to generate, for a creative image, feedback associated with the score describing at least one feature of the set of features.

15. The non-transitory computer readable storage medium of claim 12, having further instructions that when executed by the processor cause the processor to:
receive, from the content provider, a first candidate creative image for the content item for the target audience;
receive, from the content provider, user information describing the target audience for the first candidate creative image, the target audience including a target plurality of users of the online system;
provide the first candidate creative image and the user information as input to the model;
generate, by the model, a first score for the first candidate creative image; and
provide the first score for display on a client device of the content provider.

16. The non-transitory computer readable storage medium of claim 15, having further instructions that when executed by the processor cause the processor to:
receive, from the content provider, a second candidate creative image for the content item for the target audience;
provide the second candidate creative image and the user information as input to the model;
generate, by the model, a second score for the second candidate creative image; and
provide the second score for display on the client device of the content provider.

17. The non-transitory computer readable storage medium of claim 16, having further instructions that when executed by the processor cause the processor to:
responsive to the second score being higher than the first score, provide to the content provider a recommendation on which candidate creative image should be included in the content item for the target audience.

18. The non-transitory computer readable storage medium of claim 12, wherein the actions include at least one of: viewing a media of a content item, clicking a URL of a content item, liking a content item, commenting on a content item, and sharing a content item.

19. The non-transitory computer readable storage medium of claim 12, wherein the content information describes at least, for each content item of the plurality of content items, a content value indicating a compensation that the online system receives for providing the content item for display on the client devices.

20. The non-transitory computer readable storage medium of claim 12, wherein identify the set of features further comprises:
identify a reference creative image of a content item of the plurality of content items; and
extract an image feature from the reference creative image, wherein the set of features includes the image feature.
